(19) United States
(12) Patent Application Publication
(10) Pub. No.: US 2013/0281598 A1
(43) Pub. Date: Oct. 24, 2013

(54) CURED FLUOROELASTOMER COMPOSITIONS CONTAINING MAGNESIUM SILICATE FILLER

(71) Applicant: KOSTANTINOS KOURTAKIS, Media, PA (US)

(72) Inventor: KOSTANTINOS KOURTAKIS, Media, PA (US)

(73) Assignee: E I DU PONT DE NEMOURS AND COMPANY, Wilmington, DE (US)

(21) Appl. No.: 13/449,399

(22) Filed: Apr. 18, 2012

(51) Int. Cl. C08K 3/34; B82Y 30/00

(52) U.S. Cl. 524/451; 977/755

(57) ABSTRACT

Cured fluoroelastomer compositions containing a phyllosilicate of the formula Mgₓ Si₇₋ₓ O_{(28-2x)/2-(y/2)} (OH)_{y}, wherein x=1 to 5 and y=0 to (28-2x), said phyllosilicate having an average length of at least 50 nm in at least one dimension and an aspect ratio >3:1 are disclosed.

### FIELD OF THE INVENTION

This invention pertains to cured fluoroelastomer compositions filled with a phyllosilicate of magnesium silicate.

### BACKGROUND OF THE INVENTION

Fluoroelastomers are well known in the art; see for example U.S. Pat. Nos. 4,214,060; 4,281,092; 5,789,489; 6,512,063 and 6,924,344 B2. They may be partially fluorinated (i.e. contain copolymerized units of at least one monomer having C—H bonds such as vinylidene fluoride, ethylene or propylene) or be perfluorinated (i.e. contain copolymerized units of monomers not having C—H bonds). Examples of fluoroelastomers include, but are not limited to copolymers of i) vinylidene fluoride, hexafluoropropylene and, optionally, tetrafluoroethylene; ii) vinylidene fluoride, perfluoro(methyl vinyl ether) and, optionally, tetrafluoroethylene; iii) tetrafluoroethylene and propylene; and iv) tetrafluoroethylene and perfluoro(methyl vinyl ether). Optionally, the fluoroelastomer may further comprise copolymerized units of a cure site monomer to assist in the crosslinking of the elastomer.

Shaped fluoroelastomer articles (e.g. seals, gaskets, tubing, etc.) are typically made by first compounding the fluoroelastomer with other ingredients such as filler, curative, process aids, colorants, etc., shaping the compound (e.g. by extrusion though a die or by molding) and then curing the shaped article.

Carbon blacks, which are approximately spherical in shape, are typically employed as filler. This improves some of the mechanical properties of the fluoroelastomer composition (e.g. tensile modulus), but may negatively impact other properties such as elongation at break, compression set resistance and tear strength.

### SUMMARY OF THE INVENTION

One aspect of the present invention is a cured composition comprising:
A) fluoroelastomer; and
B) 0.1 to 40 parts by weight, per hundred parts by weight fluoroelastomer, of a phyllosilicate of the formula Mgₓ Si₇₋ₓ O_{(28-2x)/2-(y/2)} (OH)_{y}, wherein x=1 to 5 and y=0 to (28-2x), said phyllosilicate having an average length of at least 50 nm in at least one dimension and an aspect ratio >3:1.

### DETAILED DESCRIPTION OF THE INVENTION

The present invention is directed to a cured fluoroelastomer composition that contains plate-like phyllosilicates of a magnesium silicate.

The fluoroelastomer that may be employed in the composition of the invention may be partially fluorinated or perfluorinated. Fluoroelastomers preferably contain between 25 and 70 weight percent, based on the total weight of the fluoroelastomer, of copolymerized units of a first monomer which may be vinylidene fluoride (VF₂) or tetrafluoroethylene (TFE). The remaining units in the fluoroelastomers are comprised of one or more additional copolymerized monomers, different from said first monomer, selected from the group consisting of fluoromonomers, hydrocarbon olefins and mixtures thereof. Fluoromonomers include fluorine-containing olefins and fluorine-containing vinyl ethers.

Fluorine-containing olefins which may be employed to make fluoroelastomers include, but are not limited to vinylidene fluoride (VF₂), hexafluoropropylene (HFP), tetrafluoroethylene (TFE), 1,2,3,3,3-pentafluoropropene (1-HPFP), 1,1,3,3,3-pentafluoropropene (2-HPFP), chlorotrifluoroethylene (CTFE) and vinyl fluoride.

Fluorine-containing vinyl ethers that may be employed to make fluoroelastomers include, but are not limited to perfluoro(alkyl vinyl) ethers. Perfluoro(alkyl vinyl) ethers (PAVE) suitable for use as monomers include those of the formula

CF₂═CFO(R_{f′}O)ₙ(R_{f″}O)ₘR_{f} (I)

where R_{f′}and R_{f″}are different linear or branched perfluoroalkylene groups of 2-6 carbon atoms, m and n are independently 0-10, and R_{f} is a perfluoroalkyl group of 1-6 carbon atoms.

A preferred class of perfluoro(alkyl vinyl) ethers includes compositions of the formula

CF₂═CFO(CF₂CFXO)ₙR_{f} (II)

where X is F or CF₃, n is 0-5, and R_{f} is a perfluoroalkyl group of 1-6 carbon atoms.

A most preferred class of perfluoro(alkyl vinyl) ethers includes those ethers wherein n is 0 or 1 and R_{f} contains 1-3 carbon atoms. Examples of such perfluorinated ethers include perfluoro(methyl vinyl ether) (PMVE), perfluoro(ethyl vinyl ether) (PEVE) and perfluoro(propyl vinyl ether) (PPVE). Other useful monomers include those of the formula

CF₂=CFO[(CF₂)ₘCF₂CFZO]ₙR_{f} (III)

where R_{f} is a perfluoroalkyl group having 1-6 carbon atoms, m=0 or 1, n=0-5, and Z=F or CF₃. Preferred members of this class are those in which R_{f} is C₃F₇, m=0, and n=1.

Additional perfluoro(alkyl vinyl) ether monomers include compounds of the formula

CF₂═CFO[(CF₂CF{CF₃}O)ₙ(CF₂CF₂CF₂O)ₘ(CF₂)ₚ]CₓF₂ₓ₊₁ (IV)

where m and n independently=0-10, p=0-3, and x=1-5. Preferred members of this class include compounds where n=0-1, m=0-1, and x=1.

Other examples of useful perfluoro(alkyl vinyl ethers) include

CF₂═CFOCF₂CF(CF₃)O(CF₂O)ₘCₙF₂ₙ₊₁ (V)

where n=1-5, m=1-3, and where, preferably, n=1.

If copolymerized units of PAVE are present in fluoroelastomers employed in the process of the invention, the PAVE content generally ranges from 25 to 75 weight percent, based on the total weight of the fluoroelastomer. If perfluoro(methyl vinyl ether) is used, then the fluoroelastomer preferably contains between 30 and 65 wt. % copolymerized PMVE units.

Hydrocarbon olefins useful in the fluoroelastomers employed in the invention include, but are not limited to ethylene and propylene. If copolymerized units of a hydrocarbon olefin are present in the fluoroelastomers, hydrocarbon olefin content is generally 4 to 30 weight percent.

The fluoroelastomers employed in the composition of the present invention may also, optionally, comprise units of one or more cure site monomers. Examples of suitable cure site monomers include, but are not limited to: i) bromine -containing olefins; ii) iodine-containing olefins; iii) bromine-containing vinyl ethers; iv) iodine-containing vinyl ethers; v) fluorine-containing olefins having a nitrile group; vi) fluorine-containing vinyl ethers having a nitrile group; vii) 1,1,3,3,3-pentafluoropropene (2-HPFP); viii) perfluoro(2-phenoxypropyl vinyl) ether; and ix) non-conjugated dienes.

Units of cure site monomer, when present in the fluoroelastomers employed in this invention, are typically present at a level of 0.05-10 wt. % (based on the total weight of fluoroelastomer), preferably 0.05-5 wt. % and most preferably between 0.05 and 3 wt. %.

Alternatively, or in addition to units of a cure site monomer, fluoroelastomers employed in this invention may contain cure sites (e.g. Br or I) at chain ends. When present, the range of Br or I end groups is 0.005-5 wt. %, preferably 0.05-3 wt. %.

Specific examples of fluoroelastomers that may be employed in the compositions of the invention include, but are not limited to copolymers comprising i) vinylidene fluoride and hexafluoropropylene; ii) vinylidene fluoride, hexafluoropropylene and tetrafluoroethylene; iii) vinylidene fluoride and perfluoro(methyl vinyl ether); iv) vinylidene fluoride, perfluoro(methyl vinyl ether) and tetrafluoroethylene; v) tetrafluoroethylene and propylene; vi) tetrafluoroethylene and perfluoro(methyl vinyl ether); and vii) tetrafluoroethylene, perfluoro(methyl vinyl ether) and ethylene. For clarity, cure site monomers and cure site end groups are omitted from the above examples of fluoroelastomers. Preferred fluoroelastomers include copolymers comprising tetrafluoroethylene, perfluoro(methyl vinyl ether) and a cure site monomer having nitrile groups such as perfluoro(8-cyano-5-methyl-3,6-dioxa-1-octene) and copolymers comprising tetrafluoroethylene and perfluoro(methyl vinyl ether) and having predominately iodine end groups.

The phyllosilicate employed in the composition of the invention is of the formula Mgₓ Si₇₋ₓ O_{(28-2x)/2-(y/2)} (OH)_{y}, wherein x=1 to 5 and y=0 to (28-2x). X and y need not be integers. The phyllosilicate has a plate-like shape with an average length of at least 50 nm in at least one dimension and an aspect ratio >3:1. Specific examples of suitable phyllosilicates include talc (Mg₃Si₄O₁₀(OH)₂), as well as antigorite, chrysotile and lizardite (all having the formula Mg_{4.2}Si_{2.8}O₇(OH)₅₆). Talc is preferred. Preferably the talc has a platelet thickness between 50 and 500 nm and at least one average length in the basal plane of at least 1 μm.

The surface of the phyllosilicate may optionally be modified, e.g. with a fluorocarbon based silane coupling agent. Other silane coupling agents can be used which contain functional groups, allowing the phyllosilicate to crosslink with the fluoroelastomer.

The amount of phyllosilicate contained in the fluoroelastomer composition is generally between 0.1 and 40 (preferably between 1 and 40, more preferably between 10 and 30, most preferably between 10 and 20) parts by weight per hundred parts by weight fluoroelastomer.

The phyllosilicate may be added to the fluoroelastomer by conventional means, e.g. neat directly to the fluoroelastomer. Other procedures can be used in which a masterbatch of the fluoroelastomer with the phyllosilicate can be made which is then subsequently blended with additional fluoroelastomer and curative. For example, a masterbatch of phyllosilicate and aqueous fluoroelastomer emulsion may be combined and dried by freeze drying, spray drying, or by precipitation to form a solid mixture of fluoroelastomer with phyllosilicate. The solid mixture may be optionally washed or calcined to remove any surfactants that were present in the fluoroelastomer emulsion. The masterbatch may then be blended with additional fluoroelastomer and curative during a roll milling or other mixing operation.

Other additives commonly employed in fluoroelastomer compositions may be included in the compositions of the invention, e.g. other fillers, colorants, process aids, etc.).

Fluoroelastomer compositions of this invention are crosslinked (i.e. cured) with curatives typically employed in the industry, including but not limited to polyols, polyamines, bis(aminophenols), compounds that decompose to release ammonia at curing temperatures and organic peroxides with coagents. Curable compositions are made by combining the ingredients in a mixer, e.g. a 2-roll rubber mill, extruder, or an internal mixer such as a Banbury®. Generally, the curable compositions are shaped and then cured.

The fluoroelastomer compositions of this invention form cured articles that are useful in many industrial applications including seals, wire coatings, tubing and laminates. The cured articles exhibit improved modulus and tear strength vs. similar articles absent the phyllosilicate.

### EXAMPLES

### TEST METHODS

The following physical properties were obtained according to methods described in ASTM D 412 at the temperatures indicated in the Table.
T_{B}, tensile strength at break (MPa)
E_{B}, elongation at break (%)
M₅₀, modulus at 50% elongation (MPa)

Tear resistance (force required to propagate a tear divided by sample thickness, N/mm) was performed at 200° C. according to ASTM D1938-08.

The fluoroelastomer gums employed in the examples were

Polymer A—a copolymer of tetrafluoroethylene and perfluoro(methyl vinyl ether) having predominately iodine end groups.

Polymer B—a copolymer of tetrafluoroethylene, perfluoro(methyl vinyl ether) and perfluoro(8-cyano-5-methyl-3,6-dioxa-1-octene), prepared according to the general process described in U.S. Pat. No. 5,789,489.

### Example 1

A curable fluoroelastomer composition of the invention was made by blending on a 2-roll rubber mill 60.67 phr Polymer A, 39.33 phr Polymer B, 1.5 phr organic peroxide curative (Luperox® HP101XLP, available from Arkema), 1 phr coagent (TAIC DLC-A, available from Harwick Standard Distribution Corp.), 5 phr N990 MT carbon black (available from Cancarb Ltd.) and 16.85 phr of talc (FlexTalc® 310, available from Kish Company, Inc.). “phr” is parts by weight per 100 parts by weight rubber, i.e. fluoroelastomer.

The resulting fluoroelastomer composition was molded into o-rings and cured at 165° C. for 8 minutes. The o-rings were than post cured under nitrogen at 305° C. for 26 hours, after a slow ramp up in temperature from room temperature.

Tensile properties of o-rings and tear resistance of 2 mm thick cured films are shown in the Table.

### Comparative Example A

A procedure similar to that described in Example 1 was employed except that no talc was added and 35 phr of N990 MT carbon black was used in place of 5 phr carbon black.

Tensile properties and tear resistance results are shown in the Table. The M₅₀ at 60° and 200° C., as well as the tear resistance at 200° C. was better for the cured fluoroelastomer composition of Example 1 than for that of Comparative Example A.

TABLE

| | Comp. Example A | Example 1 |
|---|---|---|
| Physical Properties, | | |
| 60° C. | | |
| T_{B}, MPa | 15.32 | 14.08 |
| E_{B}, % | 158 | 200 |
| M₅₀, MPa | 2.8 | 4.83 |
| Physical Properties, | | |
| 200° C. | | |
| T_{B}, MPa | 5 | 6 |
| E_{B}, % | 85 | 85 |
| M₅₀, MPa | 2.3 | 4.34 |
| Tear Strength, N/mm | 0.27 | 0.48 |

1. A cured composition comprising:
A) fluoroelastomer; and
B) 0.1 to 40 parts by weight, per hundred parts by weight fluoroelastomer, of a phyllosilicate selected from the group consisting of talc, antigorite, chrysotile and lizardite, said phyllosilicate having an average length of at least 50 nm in at least one dimension and an aspect ratio >3:1.

2. (canceled)

3. The cured composition of claim 1 wherein said phyllosilicate is talc.

4. The cured composition of claim 3 wherein said talc has a platelet thickness between 50 and 500 nm and at least one average length in the basal plane of at least 1 μm.

5. The cured composition of claim 1 wherein said phyllosilicate is present in an amount of 1 to 40 parts by weight, per hundred parts by weight fluoroelastomer.

6. The cured composition of claim 5 wherein said phyllosilicate is present in an amount of 10 to 30 parts by weight, per hundred parts by weight fluoroelastomer.

7. The cured composition of claim 6 wherein said phyllosilicate is present in an amount of 10 to 20 parts by weight, per hundred parts by weight fluoroelastomer.

8. The cured composition of claim 1 wherein said fluoroelastomer comprises copolymerized units selected from the group consisting of i) vinylidene fluoride and hexafluoropropylene; ii) vinylidene fluoride, hexafluoropropylene and tetrafluoroethylene; iii) vinylidene fluoride and perfluoro(methyl vinyl ether); iv) vinylidene fluoride, perfluoro(methyl vinyl ether) and tetrafluoroethylene; v) tetrafluoroethylene and propylene; vi) tetrafluoroethylene and perfluoro(methyl vinyl ether); and vii) tetrafluoroethylene, perfluoro(methyl vinyl ether) and ethylene.
